SEQUENCE LISTING (5 sequences)

SEQ ID NO: 1 - protein, 236 aa, Artificial Sequence
  HyHEL10 scFv
DIVLTQSPATLSVTPGNSVSLSCRASQSIGNNLHWYQQKSHESPRLLIKYASQSISGIPSRFSGSGSGTDFTLSINSVETEDFGMYFCQQSNSWPYTFGGGTKLIITAGGGGSGGGGSGGGGSDIQLQESGPSLVKPSQTLSLTCSVTGDSITSDYWSWIRKFPGNRLEYMGYVSYSGSTYYNPSLKSRISITRDTSKNQYYLDLNSVTTEDTATYYCANWDGDYWGQGTLVTVSA

SEQ ID NO: 2 - DNA, 708 bp, Artificial Sequence
  HyHEL10 scFv coding DNA
gatatcgtcctgacccagagcccggcgaccctctcggtcacccccggcaactcggtgtccctctcgtgccgcgcctcgcagtcgatcggcaacaacctccactggtatcagcagaagtcgcacgagagcccgcgcctcctgatcaagtacgccagccagtcgatctcggggatcccgtcgcgcttcagcggctcgggctcgggcaccgacttcaccctgtcgatcaacagcgtcgagacggaggacttcggcatgtacttctgccagcagtcgaacagctggccgtacaccttcggcggcggtaccaagctgatcatcacggccggcgggggcggtagcggcggtggcgggtcgggcggtggcggatcggatatccagctgcaggagtcgggcccgagcctcgtcaagccgtcgcagaccctgtcgctcacctgcagcgtcaccggcgactcgatcacctcggactactggtcgtggatccgcaagttccccggcaaccgcctcgagtacatgggctacgtcagctactcgggcagcacctactacaacccctcgctgaagagccgcatctcgatcacccgcgacacctccaagaaccagtactacctggacctcaactcggtcaccaccgaggacaccgccacctactactgcgcgaactgggacggcgactactggggccagggcaccctcgtcaccgtctccgcg

SEQ ID NO: 3 - protein, 120 aa, Artificial Sequence
  gold binding VH
QVQLVESGAEVKKAGESLKISCKGSGYSFPSYWINWVRQMPGKGLEWMGMIYPADSDTRYSPSFQGHVTISADKSINTAYLQWAGLKASDTAIYYCARLGIGGRYMSRWGQGTLVTVSSA

SEQ ID NO: 4 - DNA, 357 bp, Artificial Sequence
  gold binding VH encoding DNA
caggtgcagttggtggagtctggagcagaggtgaaaaaggccggggagtctctgaagatctcctgtaagggatctggatacagctttcccagttactggatcaactgggtgcgccagatgcccggcaaaggcctggaatggatggggatgatctatcctgctgactctgataccagatatagcccgtccttccaaggccacgtcaccatctcagccgacaagtccatcaacaccgcctacctgcaatgggccggcctgaaggcctcggacaccgccatatattactgtgcgagacttggaattggtgggaggtacatgtctagatggggccagggaaccctggtcaccgtctcctca

SEQ ID NO: 5 - protein, 15 aa, Artificial
  linker
GGGGSGGGGSGGGGS

(19) United States
(12) Patent Application Publication
(10) Pub. No.: US 2007/0298510 A1
(43) Pub. Date: Dec. 27, 2007

(54) Target substance-detecting element, detecting material, and detector kit

(75) Inventors: Takeshi Imamura, Chigasaki-shi (JP); Takashi Ikeda, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/727,674

(22) Filed: Mar. 28, 2007

(30) Foreign Application Priority Data
Apr. 4, 2006 (JP) 2006-102985

(51) Int. Cl. G01N 27/00

(52) U.S. Cl. 436/149

(57) ABSTRACT

A kit for detecting a target substance in a specimen or measuring the concentration of the target substance comprises an element comprising a magnetic field-detecting site, a first peptide molecule capable of bonding specifically to the target substance and a site for immobilizing the first peptide molecule, a marker material comprising a particle containing a magnetic material and a second peptide molecule capable of bonding specifically to the target substance which second peptide molecule is immobilized on the particle, the first and second peptide molecules being bonded specifically at different regions of the target substance, and at least one of the first and second peptide molecules having a molecular weight lower than an immunoglobulin G molecule.

### BACKGROUND OF THE INVENTION

1. Field of the Invention

The present invention relates to a detecting element, detecting material, and a detector kit, for detecting magnetically a target substance in a specimen.

2. Description of the Related Art

The biodetector is a measurement device utilizing a high ability of a living body or biological molecule for molecule identification. The living body contains combinations of affinitive substances such as enzyme-substrate, antigen-antibody, and DNA-DNA. The biodetector holds or immobilizes one component of the combination on a substrate, and detects selectively by reaction with the other component of the combination. In recent years, the biodetectors are promising in variety of application fields, not only in medical fields but also in environmental technical fields and foodstuff fields. For adaptation to the wide application fields, the biodetector is demanded which has a small size, a light weight, and a high detectivity for installation in a small space or for portability.

A high-detective system for detecting a target substance is being investigated actively for detecting the presence or quantity of a target substance in a specimen by use of a magnetic marker on or near a surface portion. In such detecting of the target substance, a first target-substance-trapping molecule which is capable of bonding specifically to a specific site of the target substance is immobilized on the surface of the detector element. This specific site is called an “epitope” when the target substance is an antigen and is detected by an antigen-antibody reaction. The first target-substance-trapping molecule, when an antigen is detected by an antigen-antibody reaction, is called a “first antibody” (or a “primary antibody”) in the present invention. On contact of the detector element with a specimen containing a target substance, the target substance is allowed to bond to the first target-substance-trapping molecule. Separately, a magnetic marker like a magnetic bead is modified by a second target-substance-trapping molecule capable of bonding specifically to the trapped target substance at a site different from the site of trapping by the first target substance. The second target-substance-trapping molecule, when an antigen is detected by an antigen-antibody reaction, is called a “second antibody” (or a “secondary antibody”) in the present invention. In the present invention, the integrate of the magnetic bead or the like with the second target substance-trap 4 held on the surface thereof is called a “magnetic marker” occasionally. The above magnetic marker is brought into contact with the target substance immobilized on the target substance-detector. Thereby, the magnetic marker is immobilized through the second target-trapping molecule to the detector element surface. The quantity or concentration of the target substance can be estimated by measuring magnetically the quantity of the magnetic marker fixed to the detector element surface.

In another method, to a specimen containing the target substance, a second target-substance-trapping molecule marked magnetically is added to form a composite constituted of the target substance and the second target-substance-trapping molecule. The composite is brought into contact with a first target-substance-trapping molecule immobilized on a detector element to immobilize the magnetic marker on the magnet-marked detector element surface.

Methods and elements for detecting a target substance by the aforementioned magnetic detection are disclosed as below. Japanese Patent Application Laid-Open No. 2001-033455 discloses an immunological detection technique in which a magnetic marker is allowed to bond to a specimen by an antigen-antibody reaction, then the marker is magnetized, and the marker is detected by a magnetic detector SQUID (superconductive quantum interference device).

International Publication No. WO2003/067258 discloses a biodetector which contains a detecting element containing a semiconductor Hall element for detecting a magnetic field generated by bonded magnetic molecules and conducts analysis of a target substance by measuring the amount of the specified magnetic molecules.

U.S. Pat. No. 5,981,297 discloses use of a magnetoresistance effect element for detecting a magnetic signal from magnetic microparticles bonded to a detector element through a second trapping molecule, a target molecule, and a first trapping molecule. Japanese Patent Publication No. 2003-526104 discloses a magnetic impedance method for analysis of a biological and/or chemical mixture by utilizing magnetic particles.

The above known methods are highly useful for detecting practically the presence or concentration by magnetic marking with high detectivity. A conventional method is described by reference to FIG. 1 illustrating schematically a detector element and vicinity thereof in immunoassay (antigen-antibody test). In FIG. 1, detector element 1 is bonded through functional film 2 to first substance-trapping molecule 3, and second target substance-trapping molecule 5 is immobilized to magnetic marker 6. Immunoglobulin G (hereinafter referred to as IgG occasionally) is employed as second target-trapping molecule 5. In this case, the detector element surface and magnetic marker 6 are apart from each other at a distance at least of “(IgG)-(target substance 4)-(IgG)”. When the magnetic particle is magnetized at magnetization M, the floating magnetic field Hr provided by magnetic marker 6 has a downward component Hz and a component Hx in the in-film direction of the detector element film, as well known, as represented by Equation 1. The unit in the formula is Oersted (Oe) (See FIG. 2)
Hz=(M/(4πμr³)) (2 cos² θ−sin² θ)
Hx=(3M/(4πμr³))sin θ·cos θ (Equation 1)
where μ denotes a magnetic permeability, r denotes a distance from the center of the magnetic particle, θ denotes an inclination from the direction perpendicular to the face of the magnetic film. Thus in the relative positions of magnetic marker 6 and detector element 1 as shown in FIG. 2, decrease of the distance between the magnetic marker and the detector element is necessary for increase of the signal intensity and for the increase of the detectivity of detecting the target substance detector element.

### SUMMARY OF THE INVENTION

The present invention intends to provide a target substance-detecting element and a marker substance for detecting the presence or quantity of a target substance by detecting of magnetism of a magnetic marker bonded to the target substance, in which the distance between the magnetic marker and the detector element in the detection can be made shorter than conventional ones. The present invention intends further to provide a kit containing the above-mentioned detector element and marker substance.

After comprehensive investigation, the inventors of the present invention have found an element, a material, and a kit containing the element and the material by solving the aforementioned problems for improving the detectivity of the magnetic detector.

The present invention is directed to an element for detecting a target substance in a specimen or measuring the concentration of the target substance in cooperation with a magnetic marker, comprising a magnetic field-detecting site, a peptide molecule capable of bonding specifically to the target substance and a site for immobilizing the peptide molecule; the peptide molecule having a molecular weight lower than an immunoglobulin G molecule.

The magnetic field-detecting site can contain any of a magnetoresistance effect element, a Hall effect element, a magnetic impedance element, and a superconductive quantum intereference device.

The present invention is directed to a target substance-detecting material as a magnetic marker for detecting a target substance in a specimen or measuring the concentration of the target substance in cooperation with a magnetic field-detecting element, comprising a particle containing a magnetic substance, and a peptide molecule capable of bonding specifically to the target substance which peptide is immobilized to the surface of the particle; the peptide molecule having a molecular weight lower than an immunoglobulin G molecule.

The magnetic field-detecting element can contain any of a magnetoresistance effect element, a Hall effect element, a magnetic impedance element, and a superconductive quantum intereference device.

The present invention is directed to a kit for detecting a target substance in a specimen or measuring the concentration of the target substance, comprising an element comprising a magnetic field-detecting site, a first peptide molecule capable of bonding specifically to the target substance and a site for immobilizing the first peptide molecule; a marker material comprising a particle containing a magnetic material and a second peptide molecule capable of bonding specifically to the target substance which second peptide molecule is immobilized on the particle; the first peptide molecule and the second peptide molecule being bonded specifically at different regions of the target substance; and at least one of the first peptide molecule and the second peptide molecule having a molecular weight lower than an immunoglobulin G molecule.

The magnetic field-detecting site can contain any of a magnetoresistance effect element, a Hall effect element, a magnetic impedance element, and a superconductive quantum intereference device.

Further features of the present invention will become apparent from the following description of exemplary embodiments with reference to the attached drawings.

### BRIEF DESCRIPTION OF THE DRAWINGS

FIG. 1 is a schematic drawing of a conventional target substance-detecting element for comparison with the one of the present invention.

FIG. 2 is a schematic drawing for describing the signal intensity in a target substance-detecting element of the present invention.

FIG. 3 is a schematic drawing of a target substance-detecting element of the present invention.

FIG. 4 is a schematic drawing of another target substance-detecting element of the present invention.

FIG. 5 is a schematic drawing of still another target substance-detecting element of the present invention.

FIG. 6 is a schematic drawing of still another target substance-detecting element of the present invention.

FIG. 7A illustrates schematically a general constitution of Example 1 of the present invention.

FIG. 7B illustrates schematically a constitution of the element of Example 1 of the present invention.

FIG. 7C illustrates schematically a constitution of comparative example in Example 1.

FIG. 7D illustrates schematically a signal detection circuit containing the target substance-detecting element in Example 1 of the present invention.

FIG. 7E illustrates schematically a cross-section of a film of a GMR element constituted by vertically magnetized films in Example 1 of the present invention.

FIG. 8A illustrates schematically a general constitution of Example 2 of the present invention.

FIG. 8B illustrates schematically a constitution of the element of Example 2 of the present invention.

FIG. 8C illustrates schematically a constitution of comparative example in Example 2.

FIG. 9A illustrates schematically a general constitution of Example 3 of the present invention.

FIG. 9B illustrates schematically a constitution of the element of Example 3 of the present invention.

FIG. 9C illustrates schematically a constitution of comparative example in Example 3.

FIG. 10A illustrates schematically a general constitution of Example 4 of the present invention.

FIG. 10B illustrates schematically a constitution of the element of Example 4 of the present invention.

FIG. 10C illustrates schematically a constitution of comparative example in Example 4.

### DESCRIPTION OF THE EMBODIMENTS

The target substance-detecting element, the target substance-detecting marker material, and the target substance detector kit of the present invention, which are used in combination with a magnetic marker and a magnetism detecting element, are useful for detecting the presence or concentration of a target substance in a specimen.

The target substance-detecting element of the present invention has at least a site detectable by a magnetic field (hereinafter referred to as a “magnetic detection site” occasionally), a peptide molecule capable of bonding specifically to a target substance, and a site for immobilizing the peptide molecule (hereinafter referred to as a “peptide-immobilizing site” occasionally). The present invention is characterized in that the peptide molecule has a molecular weight lower than immunoglobulin-G molecule. In the constitution of the detecting element, when the peptide molecule is immobilized on the surface of a magnetic detection site, the magnetic detection site may be employed as the peptide-immobilizing site. The detecting element may include one or more substrates. The magnetic detection site may be placed on the substrate. The substrate may be employed as the peptide-immobilizing site. The magnetic detection site and the peptide molecule may be placed on one and the same substrate or on separate substrates. The target substance-detecting element of the present invention may include a substrate immobilizing the peptide molecule independently of the magnetic detection site, and in detecting, the substrate immobilizing the peptide and the magnetic detection site may be separated not to be in contact with each other. The detecting element may contain a film on the peptide molecule-immobilizing site for immobilizing the peptide molecule: such a film is hereinafter referred to as a “functional film” occasionally.

The material of the marker for detecting a target substance in the present invention includes a particle containing a magnetic substance, and a peptide molecule capable of bonding specifically to the target substance. The peptide molecule is immobilized on the surface of the magnetic substance-containing particle. The peptide has a molecular weight lower than an immunoglobulin-G molecule. The magnetic substance-containing particle may have a film functioning for immobilizing the peptide molecule on the particle surface. (Hereinafter the film is referred to as a “functional film” occasionally.)

The target substance-detecting kit of the present invention includes (1) an element which has at least a magnetic detection site, a first peptide molecule capable of bonding specifically to a target substance, and a site for immobilizing the first peptide molecule; and (2) a material which has a particle containing a magnetic substance, and a second peptide capable of bonding specifically to the target substance and immobilized to the particle containing a magnetic substance, wherein the first peptide molecule and the second peptide molecule are capable of bonding to separate regions of the target substance, and at least one of the first peptide molecule and the second peptide molecule has a molecular weight lower than an immunoglobulin-G molecule.

The functional film in the present invention immobilizes thereon the peptide molecule capable of bonding specifically to the target substance molecule. The functional film has two functions as below: (1) to immobilize the peptide molecule effectively on the surface thereof, and (2) to prevent non-specific adsorption of a molecule other than the target molecule (in particular, to prevent direct adsorption of the magnetism-marked second peptide molecule on the element). For the above function (1) of the immobilization, a functional group for immobilizing the peptide is provided on the surface (the functional group usually including carboxyl, epoxy, and aldehyde), or gold is provided on the surface when a gold-affinitive diabody is employed as in an embodiment of the present invention. When the peptide is immobilized by physical adsorption on a somewhat cleaned surface, the special surface treatment may be omitted occasionally. For the above function (2) of prevention of the non-specific adsorption, the surface of the film may be coated with a blocking agent such as casein, PEG (polyethylene glycol), and PC (phosphatidyl choline), if necessary.

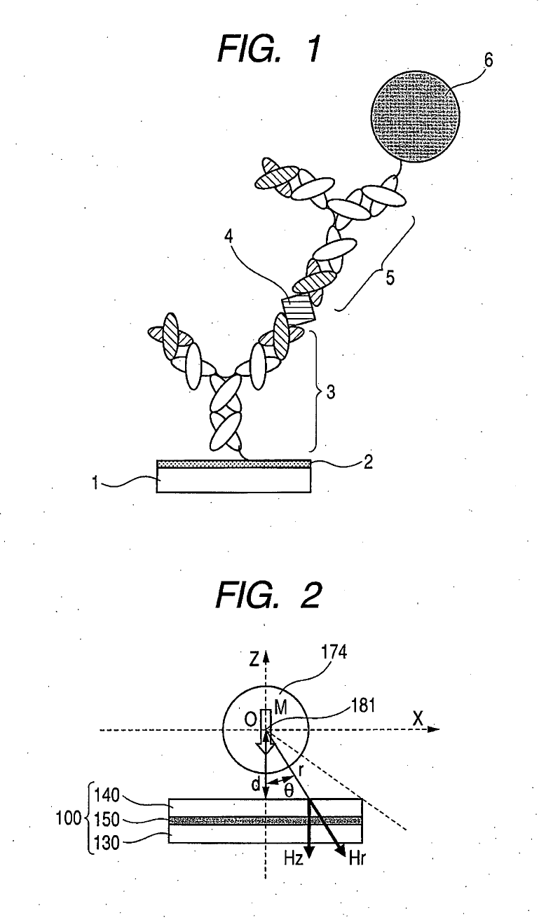

In a conventional method as shown in FIG. 1, magnetic marker 6 is apart from detector element 1 at a distance of the sum of the sizes of first target-substance-trapping molecule 3 (immobilized through functional film 2 on detector element 1), target substance 4, and second target-substance-trapping molecule 5 (modified by the magnetic marker).

A feature of the present invention is that at least one peptide molecule employed as the first target-substance-trapping molecule and the second target-substance-trapping molecule has a molecular weight lower than that of an immunoglobulin G molecule conventionally employed as the trapping molecule.

Non-patent document, Chin. J. Traumatol. 8(5), 277-82, 2005, describes that IgG has a size of 13.641×6.28×2.61 nm by AFM observation. Non-patent document, Ultramicroscopy. 105(1-4), 103-10, 2005, describes that the average of the maximum diameter of a fragment of a molecular weight of 50,000 corresponding to Fab, a fraction of IgG is 7.56 nm according to AFM observation. Thereby, the peptide molecule as the target-substance-trapping molecule is proved to be shorter when the peptide molecule has a molecular weight lower than that of immunoglobulin G.

Preferred embodiments are described below in detail.

Firstly, the peptide molecule in the present invention is described. The peptide molecule is a compound formed from two or more α-amino acids by an amide linkage (i.e., peptide linkage), including polypeptides and proteins. The peptide molecule in the present invention is capable of identifying specifically a certain region of a target substance and bonding thereto, and has a molecular weight lower than that of an immunoglobulin G. The immunoglobulin G molecule has the lowest molecular weight among the five classes of immunoglobulins, and is constituted of two H chains (molecular weight ranging from 50,000 to 70,000) and two L chains (molecular weight ranging from 20,000 to 30,000), thus having a molecular weight of about 150,000 (ranging from 140,000 to 170,000).

The peptide molecule of the present invention includes antigens, receptor proteins, enzymes, or like molecules having a site for bonding to a target substance, and has a molecular weight lower than immunoglobulin G.

The molecule having a site for bonding to an antibody as the target substance includes molecules containing a sectional region of the immunoglobulin G molecule, specifically F(ab′)2, Fab′, and Fab of the immunoglobulin G molecule, and molecules containing a portion thereof. Further the peptide molecule includes molecules containing a variable region (Fv) of the immunoglobulin G and molecules containing a portion of the variable region. Further the peptide molecule includes molecules containing a variable region of the heavy chain (VH) of the immunoglobulin G molecule and molecules containing a portion thereof, and molecules containing variable regions of the light chain (VL) of the immunoglobulin G molecule and molecules containing a portion thereof.

The variable region (Fv) of the immunoglobulin G may be a variable region of the heavy chain (VH) or a variable region of the light chain (VL). Therefore, the aforementioned portion of the variable region of the immunoglobulin G may be the variable region of the heavy chain (VH) or the variable region of the light chain (VL).

A peptide molecule having a specific affinity to the target substance can be selected by using a peptide chain of 5-30 amino acids as a library by a technique of an in-vitro molecular evolution method such as phage display for use in the present invention.

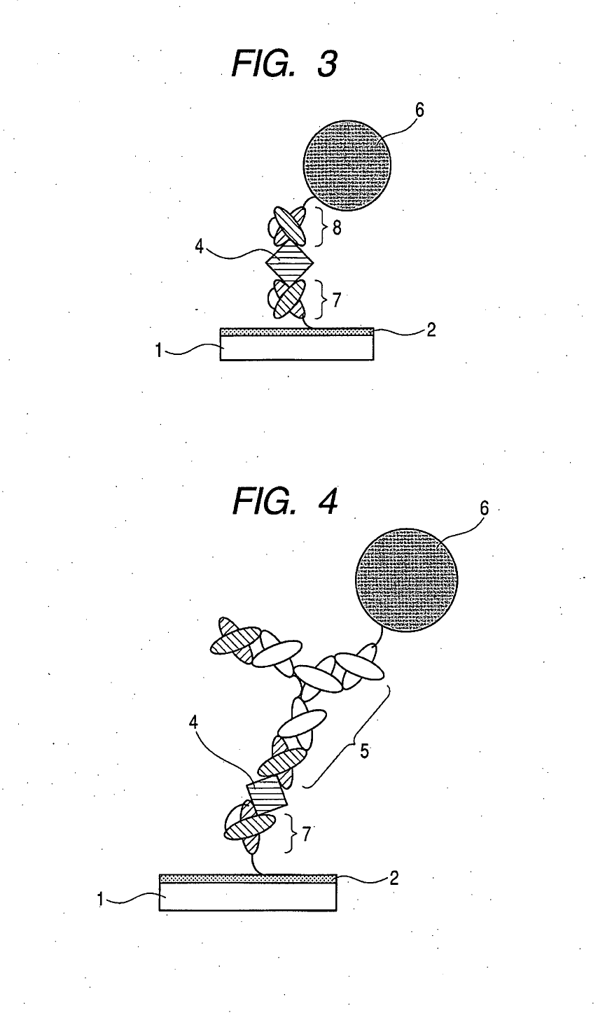

FIG. 3 illustrates schematically the case in which molecules of variable regions (Fv) of an immunoglobulin G are employed as the peptide molecule of the first trapping molecule and the second trapping molecule. In FIG. 3, the numeral 7 denotes a molecule of a variable region (Fv) of the immunoglobulin G employed as the first target-substance-trapping molecule, and the numeral 8 denotes a molecule of a variable region (Fv) of the immunoglobulin G employed as the second target-substance-trapping molecule.

The variable region (Fv) of the immunoglobulin G molecule serves as the unit for controlling the specific affinity or bonding ability of the immunoglobulin G molecule to the target substance, and has the same specific affinity or bonding ability as the immunoglobulin G, in principle. The molecular weight of the variable region (Fv) is about ⅙ times the molecular weight of the immunoglobulin G, and the size of the variable region (Fv) ranges from 2 to 3 nm which size is less than ⅕ of the immunoglobulin G having a size of about 15 nm. Therefore, the distance between the detector element surface and the magnetic marker is shortened by about 25 nm at the maximum, and the signals obtained from the magnetic marker is stronger correspondingly.

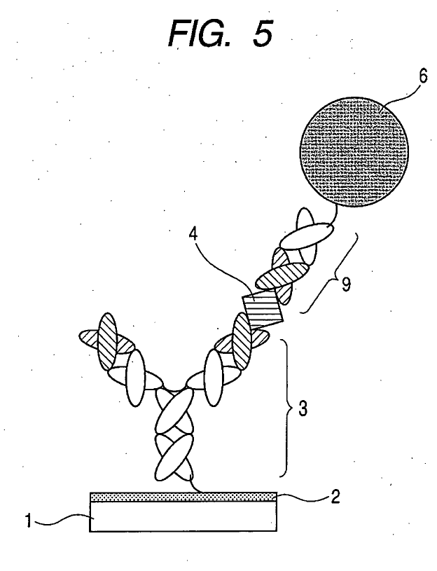

The combination of the molecules may be varied depending on the relative molecular structure to the target substance, the productivity, and the ease of immobilization of the trapping molecules. For example, in FIG. 4, a variable region (Fv) molecule 7 of the immunoglobulin G molecule is employed as the first trapping molecule, and an immunoglobulin G molecule 5 is employed as the second trapping molecule. In FIG. 5, immunoglobulin G molecule 3 is employed as the first trapping molecule, and Fab molecule 9 of the immunoglobulin G molecule is employed as the second trapping molecule.

The method of immobilization of the peptide molecule on the element or the magnetic marker is not limited insofar as the state of the bonding of the respective peptide molecules through the target molecule to the magnetic marker and the element can be retained effectively until the detecting is conducted. The method of the immobilization includes chemical bonding like covalent bonding, and molecular interaction between an antigen and antibody.

For example, International Publication No. 2005/095461 discloses a gold-binding protein having the constitution mentioned below. When a gold thin film is employed as the functional film on the detector element surface, the gold-binding protein containing the first and second domains mentioned below can be used as the first trapping molecule. Thus, the gold-binding protein having the first and second domains mentioned below can be used as the first trapping molecule. Hereinafter the gold-binding protein is referred to as a “gold-binding diabody” occasionally.

(1) The first domain of the gold-binding protein has a gold-binding site and contains at least a fraction of the variable region (VL) of the light chain of an immunoglobulin G or a fraction of the variable region (VH) of the heavy chain of an immunoglobulin G.

(2) The second domain of the gold-binding protein has a site of bonding to the target substance and contains at least a fraction of the variable region (VL) of the light chain of an immunoglobulin G or a fraction of the variable region (VH) of the heavy chain of an immunoglobulin G.

Further, by forming at least a portion of the surface of the magnetic marker from gold, the above gold-binding protein can be employed as the second trapping molecule.

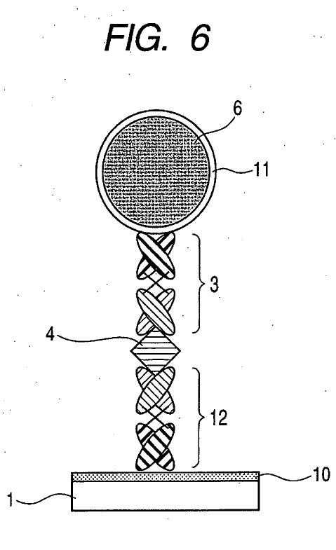

In use of the gold-binding protein, the first domain serves as an anchor for immobilization on the detector element or the magnetic marker, enabling simple immobilization of the trapping molecule with the trapping capability retained. FIG. 6 illustrates this state schematically. In FIG. 6, gold-binding protein 12 having the aforementioned constitution is immobilized as the first trapping molecule on the detector element having a surface covered with gold thin film 10. The target substance bonds to the first trapping molecule. Another gold-binding protein 13 having the aforementioned constitution is immobilized as the second trapping molecule on magnetic marker 6 coated with gold thin film 11. The target substance bonds to the second trapping molecule at the site different from the bonding of the first trapping molecule. Such a gold-binding protein molecule has a size of 5 nm. By using the gold-binding protein as the first trapping molecule and the second trapping molecule, the distance between the magnetic marker and the detector element is decreased by about 20 nm at the maximum in comparison with the distance with the immunoglobulin G molecules. This decrease of the distance improves the signal intensity. Moreover, the gold-binding protein need not be chemically modified for immobilization on the detector element or the marker material. Thus, the gold-binding protein is suitable as the trapping molecule which does not impair the affinity or bonding property to the target substance. Therefore the gold-binding diabody is suitably used as at least one of the first and second peptide molecules in the element, material, or kit of the present invention.

In recent years, peptides are being investigated and developed which are constituted of a sequence of 5-20 amino acid residues and capable of bonding to various target substances. Such peptide molecules are useful in the present invention. Such a peptide molecule can be obtained for the intended target substance by a molecular evolution technique such as a phage display method and a ribosome display method. For isolating the peptide by a phage display method, a peptide library is necessary (phage library for the phage display method), and can be prepared in situ. Otherwise, the library can be prepared by using a phage display kit for peptide ligand search like the one supplied by New England Biolabs Co. (NEB).

The magnetic substance to be contained in the particle for constituting the magnetic marker material in the present invention includes magnetic microparticles and magnetic beads having paramagnetism or superparamagnetism. Widely used ones are mixtures of an iron oxide particles such as ferrite and magnetite, and a polymer of a type of styrene, dextran, or acrylamide. The size of the magnetic microparticles and magnetic beads can be selected depending on the shape and size of the detector element and use thereof: generally the diameter ranges preferably from tens to hundreds micrometers.

The type of detecting with the target substance-detecting element of the present invention is not limited insofar as the element can utilize the magnetic field effect. Particularly preferred elements include magnetoresistance effect elements, Hall effect elements, magnetic impedance elements, and superconductive quantum interferometer. Such an element is contained in the site for detecting the magnetic field in the constitution of the target substance-detecting element. The method of detecting with in the element, material, and kit of the present invention is selected from so-called magnetic detecting methods. Of these, preferred are one or more of the detecting methods employing the magnetic field effect. The particularly preferred elements include magnetoresistance effect elements, Hall effect elements, magnetic impedance elements, and superconductive quantum interferometer.

The target substance which can be detected by the detecting element of the present invention has two regions: a region which can be identified by and can bond to the aforementioned first peptide molecule, and another region which can be identified by and can bond to the aforementioned second peptide molecule.

The target substance to be detected includes biological substances such as nucleic acids, proteins, sugar chains, lipids, and composites thereof. The present invention can be applied to any substance which contains a substance selected from the group of DNAs, RNAs, aptamers, genes, chromosomes, cell membranes, viruses, antigens, antibodies, lectins, haptens, hormones, receptors, enzymes, peptides, sphingo-sugars, and sphingo-lipids. Further, the bacteria and cells which produces the above “biological substance” can be the target substance as the biological substance.

Specific example of the proteins (lipid-proteins, glycoproteins, protein conjugates, protein polymers, etc.) are so-called disease markers.

Examples of the disease markers are enumerated below: acidic oligoprotein which is produced in a hepatocyte in a fetus stage and existing in a fetus blood; α-fetoprotein which is a marker for hepatoma (primary hepatoma), hepatoblastoma, metastatic hepatoma, and Yokesack tumor; PIVKA-II which is abnormal prothrombin expressing at liver parenchyma damage and emerging in hepatoma; BCA225 which is a glycoprotein serving as a breast-carcinoma-specific antigen immuno-histochemically, and serving as a marker for primary progressive breast carcinoma and recurrent-metastatic breast carcinoma; basic fetoprotein (BFP) which is a basic fetoprotein discovered in the extracts of serum, intestine, and brain tissue of human fetuses, and a marker for overy cancer, orchioncus, prostate cancer, pancreas cancer, biliary cancer, hepatoma, kidney cancer (renal cancer), pulmonary cancer, stomach cancer, urinary bladder cancer, and large intestine cancer; CA15-3, a sugar chain antigen which is a marker for progressive breast cancer, recurrent breast cancer, primary breast cancer, and overy cancer; CA19-9, a sugar chain antigen which is a marker for panchreas cancer, biliary cancer, stomach cancer, hepatoma, large intestine cancer, and overy cancer; CA72-4, a sugar chain antigen which is a marker for overy cancer, breast cancer, colon/rectum cancer, stomach cancer, and pancreas cancer; CA125, a sugar chain which is a sugar chain marker for overy cancer (in particular, serous cystadenocarcidoma), uterine corpus glandular cancer, fallopian tube cancer, cervical carcinoma, pancreas cancer, pulmonary cancer, and large intestine cancer; CA130, a glydoprotein which is a marker for epithelial ovarian cancer, fallopian tube cancer, pulmonary cancer, liver cell cancer, and pancreas cancer; CA602, a core protein antigen which is a marker for overy cancer (in particular, serous cystadenocarcidoma), uterine corpus glandular cancer, and cervical carcinoma; CA54/61 (CA546) mother nucleous sugar chain-related antigen which as a marker for overy cancer (in particular, mucous cyctadenocarcidoma), cervical carcinoma, and uterine corpus glandular cancer; carcinoembryonic antigen (CEA) which is widely used as a tumor-related marker antigen as an adjunct to cancer diagnosis of large intestine cancer, stomach cancer, rectal cancer, biliary cancer, pancreas cancer, pulmonary cancer, breast cancer, uterus cancer, and urinary tract cancer; DUPAN-2, a sugar chain antigen which is a marker for pancreas cancer, biliary cancer, hepatoma, stomach cancer, overy cancer, and large intestine cancer; elastase 1, a pancreas-secreted protein-degrading enzyme which exists in pancreas and hydrolyzes specifically elastic fibrous elastin of connective tissue (constituting an artery wall and a tendon), and is a marker for pancreas cancer, pancreatic cyst cancer, and biliary cancer; immunosuppressive acidic protein (IAP), a glycoprotein which exists in abdominal dropsy and serum of a human cancer patient in a high concentration, and is a marker for pulmonary cancer, leukemia, esophageal cancer, pancreas cancer, overy cancer, kidney cancer (renal cancer), biliary tract cancer, stomach cancer, urinary bladder cancer, large intestine cancer, thyroid cancer, and malignant lymphoma; NCC-ST-439, a sugar chain antibody which is a marker for pancreas cancer, biliary cancer, breast cancer, large intestine cancer, hepatoma, pulmonary adenocarcinoma, and stomach cancer; γ-seminoprotein (γ-Sm), a glycoprotein which is a maker of prostate cancer; prostate-specific antigen (PSA) which is a glycoprotein existing only in the human prostate tissue and is extracted therefrom, and is a marker for prostate cancer; prostate acidic phosphatase (PAP) which is an enzyme secreted from prostate gland and hydrolyzes a phosphate ester under an acidic pH condition, and is a tumor marker for prostate cancer; neural-specific enolase (NSE), a glycolytic enzyme which exists specifically in neural tissue and neuroendocrine cell, and is a marker for pulmonary cancer (especially pulmonary small cell cancer), neuroblastoma, nervous system tumor, pancreas islet cancer, esophageal small cell cancer, stomach cancer, renal cancer, and breast cancer; squamous epithelium cell cancer-related antigen (SCC antigen) which is a protein extracted and purified from liver metastasis focus of uterocervical squamous cell cancer and is a marker for uterus cancer (uterocervical squamous cell cancer), pulmonary cancer, esophageal cancer, head-and neck cancer, and skin cancer; sialyl LeX-I antigen (SLX), a sugar chain antigen which is a marker of pulmonary adenocarcinoma, esophageal cancer, stomach cancer, large intestine cancer, rectal cancer, pancreas cancer, overy cancer, and uterus cancer; Span-1, a sugar chain antibody which is a marker of pancreas cancer, biliary cancer, hepatoma, stomach cancer, and large intestine cancer; tissue polypeptice antigen (TPA), a single chain polypeptide which is a marker for esophageal cancer, stomach cancer, rectal/colon cancer, breast cancer, liver cell cancer, biliary cancer, pancreas cancer, pulmonary cancer, and uterus cancer, and which is useful in combination with another tumor marker for estimation of progressive cancer and recurrence prediction and therapeutic process observation; sialyl Tn antigen (STN), a mother nucleus sugar chain-related antigen, which is a marker for overy cancer, metastatic overy cancer, stomach cancer, large intestine cancer, biliary system cancer, pancreas cancer, and pulmonary cancer; CYFRA (cytokeration) which is a tumor marker effective for detection of nonvesicular cancer, especially pulmonary epidermoid cancer; pepsinogen (PG), an inactive precursor of two pepsins (PG-I, PG-II) protein-digestive enzymes secreted into stomach fluid, which is a marker for stomach uloer (especially low stomach uloer), duodenal tumor (especially recurrent or intractable one), brunneroma, Zollinger-Ellison syndrome, and acute gastritis; C-reactive protein (CRP), an acute phase-reactive protein which is changed in blood plasma by tissue damage or infection and increases by necrosis cardiac muscle caused by acute cardiac infarction; serum amyloid A protein (SAA), an acute phase-reactive protein which is changed in blood plasma by tissue damage or infection; myoglobin, a hemoprotein having a molecular weight of about 17,500 and existing mainly in cardiac muscle and skeletal muscles, which is a marker for acute cardiac infarction, muscular dystrophy, multiple myositis, and dermatomyositis; creatine kinase (CK), an enzyme existing in soluble fractions of skeletal muscle and cardiac muscle and discharged into blood by damage of cells, which is a marker for acute cardiac infarction, hypothyroidism, progressive muscular dystrophy, and multiple myositis, including three types of isozymes of the CK-MM type ones originating from skeletal muscle, and the CK-BB type ones originating from brain and smooth muscles, and bound CK (macro-CK) formed from mitochondrion/isozyme and immunoglobulin; troponin T, a protein having a molecular weight of 39,000 which forms a troponin complex with troponin I, C on a thin filament of striated muscle, participating in controlling muscle contraction, and which is a marker for rhabdomyolysis, myocarditis, cardiac infarction, and renal insufficiency; myosin light chain I of ventricle muscle, a protein which is contained in cells in both skeletal muscle/cardiac muscle, and increases by disorder or necrosis of skeletal muscle or cardiac muscle, and which is a marker for acute cardiac infarction, muscular dystrophy, and renal insufficiency; and chromogranin A, thioredoxin; and 8-OhdG which are attracting attention as stress markers.

### EXAMPLES

The present invention is described below in more detail by reference to Examples. The present invention is not limited to the Examples, and can be modified in the material, the composition, the reaction conditions, and so forth, insofar as the detecting element and the detecting device give similar performance and achieve similar effects.

### Example 1

The model protein as the target substance is hen egg-white lysozyme (hereinafter referred to a “HEL” occasionally) in this Example. The first peptide molecule is an scFv (single chain Fv) of an anti-HEL antibody, which is immobilized on the detecting element and identifies specifically the objective region of the target substance and bonds thereto. The scFv is a single-chain variable region fragment formed by linking, by a peptide linker, of a VH and a VL of the variable region (Fv), and is the minimum unit for identifying the target substance. The second peptide molecule to be immobilized on the magnetic marker and identifies and bonds specifically to another region of the target substance is an Fab region molecule of the anti-HEL antibody. The detecting operation is conducted by a technique of TMR (tunnel magnetic resistance effect) in this Example to show the effect of the present invention.

Firstly, the scFv of the anti-HEL antibody is prepared through the steps below.

(1) Transformation by Expression Vector

Competent cell BL21 (DE3) 40 μL is transformed by use of a plasmid for expressing HEL-linked HyHEL10 scFv, described in J. Bio. Chem., 2003, 278, pp. 8979-8987. The amino acid sequence (SEQ ID NO:1) and the base sequence (SEQ ID NO:2) of the HyHEL10 scFv are shown in the annexed sequence lists.

The transformation is conducted by a heat shock through ice-cooling, heating at 42° C. for 90 sec, and ice-cooling. To the solution of the above BL21 having been transformed by the heat shock, is added 750 μL of an LB culture medium. The mixture is cultivated at 37° C. with shaking for one hour. Then the cultivated mixture is centrifuged at 6000 rpm for 5 minutes. A 650 μL portion of the supernatant fluid is discarded. The remaining supernatant fluid and the precipitated cell fraction are stirred, and the mixture is scattered over an LB/amp plate, and left standing overnight at 37° C.

(2) Preliminary Cultivation

A colony on the plate is selected at random and picked out, and cultivated in 3.0 mL of an LB/amp culture at 28° C. overnight.

(3) Main Cultivation

The above preliminary culture solution is subcultured in 750 mL of 2×YT culture medium, and cultivation is continued at 28° C. When the OD-600 exceed 0.8, IPTG is added thereto to a final concentration of 1 mM. The cultivation is conducted further at 28° C. overnight.

(4) Purification

The objective polypeptide chain in the undissoved granule fraction is purified through the steps below.

(A) Recovery of Undissoved Granules

The culture fluid obtained by the above step (3) is centrifuged at 6000 rpm for 30 minutes to obtain a precipitate as a microbial mass fraction. The microbial mass is suspended in 15 mL of a tris solution (20 mM tris in 500 mM NaCl) in an ice bath. The resulting liquid suspension is subjected to crushing by means of a French press to obtain a crushed bacterial mass suspension. The suspension is centrifuged at 12,000 rpm for 15 minutes to remove the supernatant to obtain a precipitate as a undissoved granule fraction.

(B) Solubilization of Undissoved Granule Fraction

The undissoved fraction obtained in the above step (A) is added to 10 mL of 6M guanidine hydrochloride/tris solution and immersed overnight. The mixture is centrifuged at 12,000 rpm for 10 minutes to obtain a solubilized solution as the supernatant.

(C) Metal Chelate Column

His-Bind (Novagen Co.) is used as the metal chelate column carrier. Operations of column preparation, sample loading, and washing are conducted at room temperature (20° C.) according to the supplier's manual. The intended His-tag-fused polypeptide is eluted with a 60 mM imidazole/Tris solution. The eluate is subjected to SDS-PAGE (acrylamide: 15%) to confirm the purification result by a single band.

(D) Dialysis

The eluate is dialyzed with a 6M guanidine hydrochloride/Tris solution as the external solution at 4° C. to remove the imidazole from the eluate to obtain a solution containing the objective polypeptide chain.

(E) Refolding

A solution of a polypeptide chain of scFv-Sp formed by fusion of gold-binding Fv and the above peptide is subjected to protein-refolding separately by dialysis to remove guanidine hydrochloride through the steps below.

(a) A sample of a concentration of 7.5 μM is prepared based on the molar extinction coefficients and ΔO.D. (280-320 nm) of the respective polypeptide chains by use of a 6M guanidine hydrochloride/Tris solution (dilution volume: 10 mL). Thereto β-mercaptoethanol (reducing agent) is added to a final concentration of 375 μM (50 times the protein concentration), and the reduction is allowed to proceed at room temperature in the dark for 4 hours. This sample is placed in a dialysis bag (MWCO: 14,000) as a dialysis sample.

(b) The dialysis sample is dialyzed with a 6M guanidine hydrochloride/Tris solution as the external solution with gentle stirring for 6 hours.

(c) Further the dialysis is continued by lowering the guanidine hydrochloride concentration of the external solution stepwise to 3M and 2M for 6 hours at the respective external solution concentrations.

(d) To a Tris solution, oxidized glutathione (hereinafter referred to as “GSSG”) is added to a final concentration of 375 μM, and L-Arg is added to a final concentration of 0.4 M. This solution is added to the above 2M external dialysis solution of the above step (c) to adjust the guanidine hydrochloride concentration to 1M. The pH of the dialysis solution is adjusted to pH 8.0 (4° C.) with NaOH. With this external solution the dialysis is conducted further 12 hours with gentle stirring.

(e) Similarly as in the above step (d), an L-Arg-Tris solution containing 0.5M guanidine hydrochloride is prepared. The dialysis is conducted further for 12 hours.

(f) Finally the dialysis is conducted with a Tris solution. Further, dialysis is conducted with a phosphate buffer solution (hereinafter PBS) as the external solution. After the dialysis, the dialyzed solution is centrifuged at 10000 rpm for about 20 minutes to separate an aggregate and a supernatant. The obtained supernatant has a concentration of 6.3 μM according to absorption spectrum measurement at 280 nm.

(F) Gel Filtration Purification

The above supernatant is purified by gel filtration at 4° C. with Sephadex 75 (Amasham Bioscience Co.) under the buffer solution conditions: 50mM Tris-HCl, 200 mM NaCl, 1 mM MEDTA, pH 8.0, and a flow rate of 0.7 mL/min. The obtained fraction is concentrated and is subjected to SDS-PAGE (acrylamide 17.5%) and Western Blotting with HRP-fused anti-His antibody in the same manner as above. Thereby a fraction of the objective protein is identified and is purified to obtain as a single band. Therefrom, a simple protein is isolated from the peak corresponding to about 25 kDa as scFv of the HEL antibody.

The Fab region of the anti-HEL antibody is obtained by treating an anti-HEL polychronal antibody (supplied by Rockland Co.) with pepsin in a conventional manner, reducing the treated product with 2-mercaptoethanol amine, and purifying with an affinity column and gel filtration column. The Fab region of the obtained anti-HEL antibody is immobilized on magnetic beads “Dynabeads M-270 Carboxylic Acid” (supplied by Dynal Co., average particle size 2.8 μm) by activation of the carboxyl group by carbodiimide.

The detecting device and the magnetic signal measurement are described below.

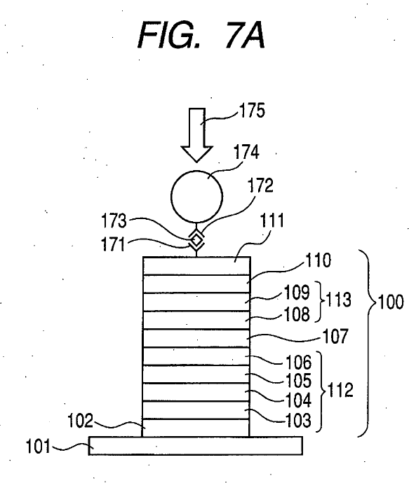

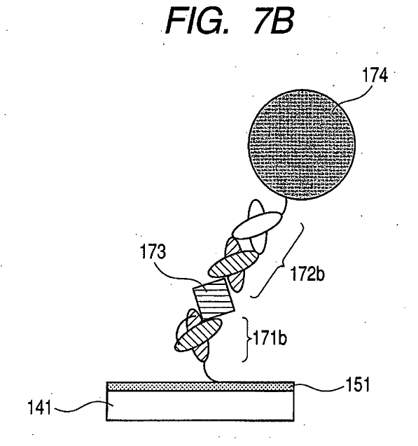

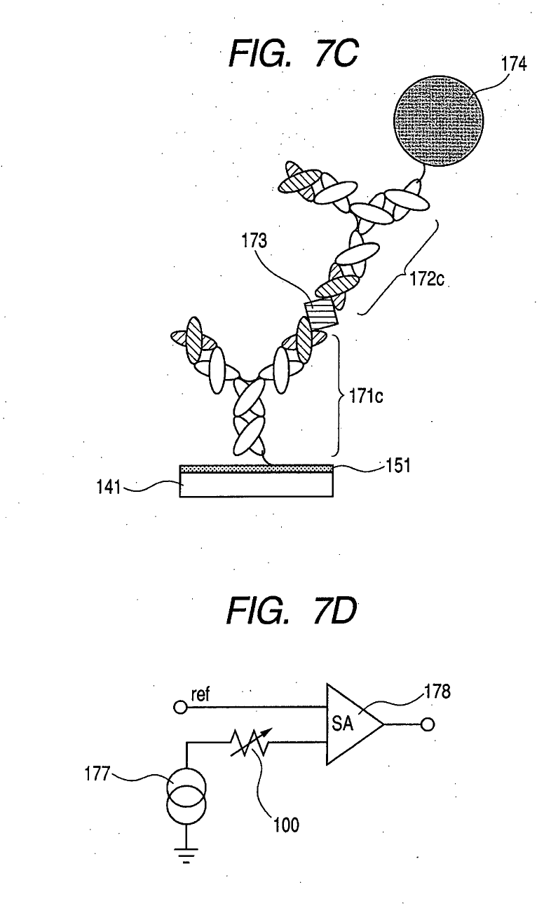

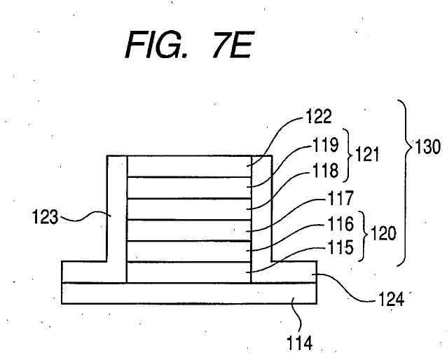

FIG. 7A illustrates schematically a cross-section of spin tunnel magnetoresistance effect element (TMR element) 100. On support 101, are formed successively hafnium film 102, manganese-iridium alloy film 103, iron-cobalt alloy film 104, ruthenium film 105, iron-cobalt alloy film 106, magnesium oxide film 107, iron-cobalt alloy film 108, nickel-iron alloy film 109, platinum film 110, and silicon film 111. Hafnium film 102 serves as a lower electrode. For higher electroconductivity of the lower electrode, a film having a higher electroconductivity such as a platinum film may be provided between support 101 and hafnium film 102. The films of manganese-iridium alloy film 103, iron-cobalt alloy film 104, ruthenium film 105, and iron-cobalt alloy film 106 form a pindo layer 112 which does not change its magnetization direction by an external magnetic field. Iron-cobalt alloy film 104 and iron-cobalt alloy film 106 are coupled magnetically tightly by magnetization in the antiparallel direction. Manganese-iridium alloy film 103 is an anti-ferromagnetic film, and is bonded to iron-cobalt alloy film 104 by exchange coupling. Iron-cobalt alloy film 108 and nickel-iron alloy film 109 are bonded to each other by exchange coupling, and constitute free layer 113 which changes its magnetization direction by an external magnetic field. Magnetic oxide film 107 is a tunnel barrier layer. Platinum film 110 is a protection layer for preventing oxidation of the magnetic films and serves as an upper electrode.

In order to support first peptide molecule 171 on the surface of silicon film 111, the surface of silicon film 111 is treated for hydrophilicity and is treated with an aminosilane coupling agent. Further, the amino group of aminosilane coupling agent and the peptide chain are chemically bonded by a crosslinking agent like glutaraldehyde to immobilize first peptide molecule 171 for trapping the target antigen.

HEL is detected with this detecting device according to the protocol shown below. The detecting device immobilizes first peptide molecule 171 capable of identifying the HEL.

(1) The above device is immersed in a phosphate buffered physiological saline containing HEL as target substance 173, and is incubated therein for 5 minutes.

(2) Unreacted HEL is washed off with a phosphate-buffered physiological saline.

(3) The detecting device having been treated in the above steps (1) and (2) is immersed in a phosphate-buffered physiological saline containing second peptide molecule 172 marked with magnetic particle 174, and is incubated therein for 5 minutes.

(4) The unreacted marked antibody is washed off with a phosphate-buffered physiological saline. Here, magnetic particle 174 has an average diameter of about 400 nm and is super-paramagnetic, and TMR element 100 is rectangular in a size of 200nm×400nm when viewed from the top side.

FIG. 7D illustrates the detecting circuit employed in this Example. Constant current source 177 is connected to TMR element 100 in series. The detecting current is allowed to flow in a direction perpendicular to the film face for tunneling through magnesium oxide film 107 of TMR element 100. The other end of TMR element 100 is connected to the input terminal of detecting amplifier 178. A signal of detecting is output from detecting amplifier 178 when difference is detected between the voltage applied to TMR element 100 and a reference voltage.

External magnetic field 175 is applied at an intensity of 600 Oe to magnetic particle 174 immobilized through the first peptide molecule, the target substance, and the second peptide molecule to direct the magnetization of magnetic particle 174 downward. Thereby a floating magnetic field is generated from magnetic particle 174, and the in-film component of this floating magnetic field affects greatly free layer 113 to turn the magnetization in the film. In the absence of magnetic particle 174 on TMR element 100, the floating magnetic field is not generated and no magnetic field is applied in TMR element 100 in the in-film direction. Thus, the magnetization state in TMR element 100 depends the presence or absence of target substance 173, so that the target substance is detected by difference of the resistance.

The detecting with the constitution illustrates in FIG. 7B is compared with that of comparative example illustrated in FIG. 7C. In this Example, scFv 171b of an anti-HEL antibody is used as the first peptide molecule, and Fab region molecule 172b of the anti-HEL antibody is used as the second peptide molecule. In the comparative example, anti-HEL polyclonal antibody 171c is used as the first peptide molecule, and anti HEL polyclonal antibody 172c is used as the second peptide molecule.

In the above comparative example, the average distance between the surface of free layer 113 and magnetic particle 174 is about 35 nm, whereas in this example of the present invention the corresponding distance is about 15 nm. Accordingly, a higher voltage is detected in this example than in the comparative example, resulting in improvement in the detection sensitivity in the present invention.

In this example, the detecting device is a TMR element constituted of in-plane magnetized films. However, the detecting device is not limited to the TMR elements, but any magnetic detector is useful. In the case where a magnetoresistance effect element is used, a giant magnetoresistance effect element (GMR element) is useful other than the TMR elements in the present invention. The construction of the GMR element resembles closely the TMR element, but has no tunnel barrier layer and has a nonmagnetic metal layer between the pindo layer and the free layer. The nonmagnetic layer is formed usually from copper. The magnetic film constituting the magnetoresistance effect element may be a vertically magnetized film in place of the in-plane magnetized film. FIG. 7E illustrates schematically a cross-section of a GMR element employing a vertically magnetized film. In FIG. 7E, GMR element has first vertically magnetized film 115, first high spin polarizability layer 116, nonmagnetic film 117, second high spin polarizability film 118, and second vertically magnetized film 119 formed successively on support 114. The two-layered exchange-coupled film constituted of first vertically magnetized film 115 and first high spin polarizability film 116 forms pindo layer 120 having the easy magnetization axis in the direction vertical to the plane, fixing the magnetization direction. First vertically magnetized film 115 is formed from an alloy film composed of terbium, iron, and cobalt, with terbium composition of 21 atom % which is near the compensation composition. First high spin polarizability film 116 and second high spin polarizability film 118 are respectively an alloy film composed of iron and cobalt having cobalt composition of 40 atom %. The two-layered exchange-coupled film constituted of second vertically magnetized film 119 and second high spin polarizability film 118 forms free layer 121. This free layer 121 need not be magnetized in the direction perpendicular to the layer plane in zero magnetic field insofar as its magnetization direction can readily be changed to be perpendicular to the layer plane. When the free layer has the magnetization direction perpendicular to the layer plane in a zero magnetic field, the coercivity of the free layer is made lower than that of pindo layer 120. Second vertically magnetized film 119 is formed from an alloy composed of gadolinium, iron, and cobalt, whereby the magnetization direction is readily changeable. Although high spin polarizability films 116,118 are respectively an in-plane magnetized when separated, the magnetization direction thereof can be made readily changeable to be perpendicular to the layer plane by exchange coupling with vertically magnetized film 115 or 119. The nonmagnetic film between free layer 121 and pindo layer 120 is formed from copper. The surface of second vertically magnetized film 119 is covered with a protection film 122 made of silicon. On both ends of GMR element 130, platinum electrodes 123,124 are formed. In detecting with the GMR element, the detecting current may be allowed to flow in any direction, perpendicular to the film plane, in an in-plane direction, or in an oblique direction. In the detecting of target substance 173 with the TMR element, an external magnetic field is applied while a detecting current is allowed to flow, and target substance 173 is detected by reading a voltage generated in GMR element 130.

### Example 2

HEL is used as the model protein of the target substance similarly as in Example 1. An Fab region molecule of an anti-HEL antibody is used as the first peptide molecule capable of identifying specifically and bonding to a specific region of the target substance. A diabody capable of identifying both HEL and gold is used as the second peptide molecule for identifying specifically and bonding to another region of the target substance different from the region identified by the first peptide molecule. A method of GMR (giant magnetic resistance effect) is used as the detecting method to describe the effect of the present invention.

The Fab region molecule of the anti-HEL antigen is prepared in the same manner as in Example 1. The diabody which is capable of identifying simultaneously both HEL and gold is prepared through the steps described below.

(1) Preparation of Expression Vector

(1) Before the VL-coding DNA sequence on the plasmid expressing HEL-linked HyHEL10 scFv, are inserted a DNA coding a gold-binding protein (SEQ ID NO:3 and SEQ ID NO: 4) and a DNA fraction SEQ ID NO:5 as a linker. The gold-binding VH and the linker code DNA are formed by a conventional overlapping PCR method. The terminals 5′ and 3′ of the gold-binding VH-coding DNA are designed to fit the framework of NcoI scission site.

The expression plasmid and the PCR product are subjected to restriction enzyme reaction with NCO1 (Takara Bio Co.) according to the supplier's manual. The restriction enzyme reaction solution is subjected to agarose gel electrophoresis.

A fraction of 0.4 kbp of the PCR product and a fraction of 3.0 kbp of the plasmid reaction solution are cut out, and are purified with a purification kit (Promega Co., trade name: Wizard SV Gel and PCR Clean-Up System). Then the obtained DNA fractions are subjected to ligation for two hours with T4-Ligase (supplied by Roche Co.).

With the obtained ligation solution, JM109 competent cell (Promega Co.) is transformed by a heat shock (ice-cooling, heating at 42° C. for 90 sec, and ice-cooling). To the solution after the heat shock, is added 750 μL of an LB culture (trypton 10 g/L, yeast extract 5 g/L, sodium chloride 10 g/L). The mixture is cultivated by shaking at 37° C. for one hour. The culture fluid is centrifuged at 6000 rpm for 5 minutes. A 700 μL portion of the supernatant is discarded. The remaining culture medium and the precipitate are stirred. The mixture is spread over an agar plate containing LB/ampicillin (100 μg/mL), and is kept standing at 37° C. for 16 hours. Ten colonies are picked out and are respectively cultivated in an LB/ampicillin liquid culture overnight.

The culture fluids are centrifuged at 6000 rpm for 5 minutes. A plasmid is recovered from the respective precipitates (bacterial masses) by use of “Minipreps SV plus DNA Purification System” (Promega Co.) according to the supplier's manual.

The obtained ten plasmid samples are subjected to DNA sequence experiment. From five out of ten samples, a plasmid can be obtained which have a gold-binding VH-code DNA inserted in an intended direction. This plasmid is called “pUT-VHGHEL10”.

(2) Transformation by Expression Vector

To the above BL21 solution containing gold-binding VH-fused scFv expression plasmid pUT-VHGHEL10 obtained in the above step (1) having been transformed by heat shock, 750 μL of an LB culture is added, and the mixture is cultivated at 37° C. for one hour with shaking. The culture fluid is centrifuged at 6000 rpm for 5 minutes. A 650 μL of the supernatant is discarded. The remaining supernatant and the precipitated cell fraction are stirred, spread over an LB/amp. plate, and left standing at 37° C. overnight.

(3) Preliminary Cultivation

A colony on the plate is selected at random and picked out, and cultivated in 3.0 mL of an LB/amp. culture at 28° C. overnight.

(4) Main Cultivation

The above preliminary culture liquid is subcultured in 750 ML of 2×YT culture medium, and cultivation is continued at 28° C. When the O.D.600 exceeds 0.8, IPTG is added thereto to a final concentration of 1 mM. The cultivation is conducted further at 28° C. overnight.

(5) Purification

The objective polypeptide chain in the undissoved granule fraction is purified through the steps shown below.

(A) Recovery of Undissoved Granules

The culture fluid obtained by the above step (4) is centrifuged at 6000 rpm for 30 minutes to obtain a microbial mass fraction as a precipitate. The microbial mass is suspended in 15 mL of a tris solution (20 mM tris in 500 mM NaCl) in an ice bath. The resulting liquid suspension is subjected to crushing by means of a French press to obtain a crushed bacterial mass suspension. The suspension is centrifuged at 12,000 rpm for 15 minutes to remove the supernatant to obtain a precipitate as a undissoved granule fraction.

(B) Solubilization of Undissoved Granule Fraction

The undissoved fraction obtained in the above step (A) is added to 10 mL of 6M guanidine hydrochloride/tris solution and is kept immersed overnight. The mixture is centrifuged at 12,000 rpm for 10 minutes to obtain a solubilized solution as the supernatant.

(C) Metal Chelate Column

His-Bind (Novagen Co.) is used as the metal chelate column carrier. Operations of column preparation, sample loading, and washing are conducted at room temperature (20° C.) according to the supplier's manual. The intended His-tag-fused polypeptide is eluted with a 60 mM imidazole/Tris solution. The eluate is subjected to SDS-PAGE (acrylamide: 15%) to confirm the purification result by a single band.

(D) Dialysis

The eluate is dialyzed with a 6M guanidine/PBS solution (8.0 g/L NaCl, mM KCl 0.2 g/L, Na₂HPO₄.12H₂O 3.6 g/L), KH₂PO₄ 0.2 g/L) as the external solution at 4° C. to remove the imidazole from the eluate to obtain a solution containing the objective polypeptide chain.

(E) Refolding

A solution of a polypeptide chain of gold-binding Fv-fused HyHEL10 scFv is subjected to protein refolding separately by dialysis to remove guanidine hydrochloride through the steps below.

(a) A sample of a concentration of 7.5 μM is prepared based on the molar extinction coefficients and ΔO.D. (280-320 nm) of the respective polypeptide chains by use of a 6M guanidine hydrochloride/PBS solution (dilution volume: 10 mL). This sample solution is placed in a dialysis bag (MWCO: 14,000) as a dialysis sample.

(b) The dialysis sample is dialyzed with a 6M guanidine hydrochloride/PBS solution as the external solution with gentle stirring for 6 hours.

(c) Further the dialysis is continued by lowering the guanidine hydrochloride concentration of the external solution stepwise to 3M and 2M for 6 hours at the respective external solution concentrations.

(d) To a PBS solution, oxidized glutathione (GSSG) is added to a final concentration of 375 μM, and L-Arg is added to a final concentration of 0.4 M. This solution is added to the above 2M external dialysis solution of the above step (c) to adjust the guanidine hydrochloride concentration to 1M. The pH of the dialysis solution is adjusted to pH 8.0 (4° C.) with NaOH. With this external solution the dialysis is conducted further 12 hours with gentle stirring.

(e) Similarly as in the above step (d), a solution of 0.5 M guanidine hydrochloride/375 μM GSSG/0.4 M L-Arg in PBS solution is prepared. The dialysis is conducted with this solution further for 12 hours.

(f) Further, dialysis is conducted with an external solution of 375 μM GSSG/0.4M L-Arg in PBS solution for 12 hours, with an external solution of 180 μM GSSG/0.2M L-Arg in PBS solution for 12 hours, and with an external solution of 90 μM GSSG/0.1M L-Arg in PBS solution for 12 hours, successively. After the dialysis, the dialyzed solution is centrifuged at 10000 rpm for about 20 minutes to separate an aggregate and a supernatant. The obtained supernatant has a concentration of 6.7 μM according to absorption spectrum measurement at 280 nm. To the solution obtained above, Tween 20 is added to a concentration of 0.005%.

(F) Purification by Gel Filtration

The above supernatant is purified by gel filtration at 4° C. with Superose 12 PC 3.2/30 (Amasham Bioscience Co.) under the buffer solution conditions: 0.005% Tween/PBS, pH 7.4, flow rate 0.7 mL/min. The obtained fraction is concentrated and is subjected to SDS-PAGE (acrylamide 12.5%) and Western Blotting with HRP-fused anti-His antibody in the same manner as above. Thereby fraction of the objective protein is identified and is obtained as a single band. Therefrom, a simple protein is isolated from the peak corresponding to about 39 kDa as a diabody which is capable of identifying simultaneously both HEL and gold.

The gold colloid-fixing superparamagnetic fine particulate which is used as the magnetic marker is prepared according to the method disclosed in Anal. Chem. 2005, 77, 1031-1037 as below.

A 0.5 mL portion of 5 mass % suspension of BioMag (amine-terminated superparamagnetic microparticle suspension, supplied by Bangs Laboratories Co.) is diluted to a final volume of 2.5 mL. (Hereinafter this suspension is referred to as a “magnetic particle solution”). A 0.25 mL portion of the above-prepared magnetic particle solution is added to 1 mL of a gold colloidal solution (average particle diameter 100 nm, supplied by BBI Co.), and the mixture is stirred. After about two hours, the particles are collected by a magnet, washed with water, and ethanol successively to obtain intended gold colloid-fixing superparamagnetic microparticles.

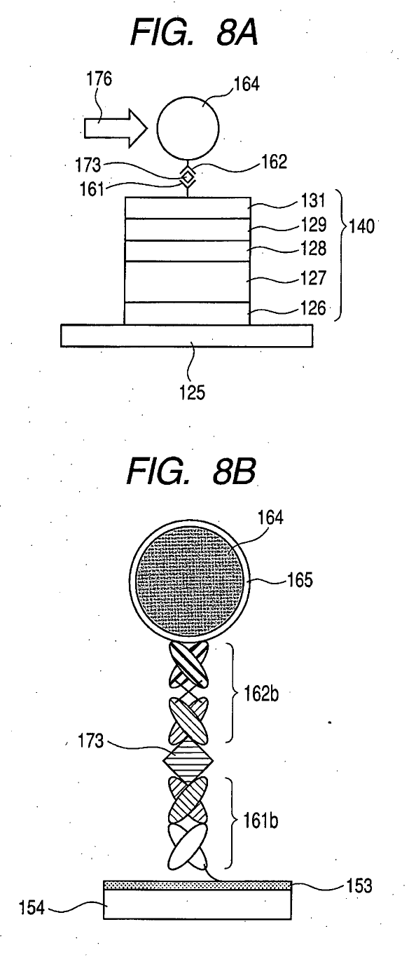

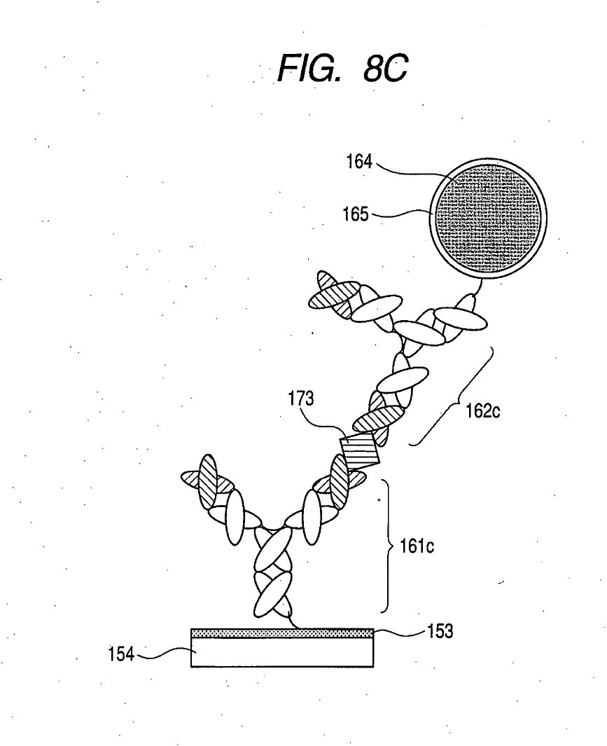

FIG. 8A illustrates schematically a cross-section of a detection device of the present invention. In this Example, the detection device employs GMR element 140 constituted of a metallic artificial lattice film. A platinum film is formed as lower electrode 126 on support 125, and thereon metallic artificial lattice film 127 is constructed by laminating alternately thereon cobalt thin films and copper thin films, each 10 layers. Further thereon, are formed successively protection film 128, a platinum film as upper electrode 129, and a silicon film as first trapping peptide molecule-immobilizing film 131.

Thereafter, in the same manner as in Example 1, magnetic particle 164 is fixed to the surface of GMR element 140 through reactions of “first peptide molecule 161, target substance, and second peptide molecule 162”. GMR element 140 is rectangular, having a short side of 90 nm and a long side of 180 nm. In this element, the easy magnetization axis is directed to the length direction of the magnetic film. In the metallic artificial lattice film, the directions of magnetization of the ferromagnetic films through a nonmagnetic film are anti-parallel in a zero magnetic field, and become parallel on application of a magnetic field in the in-plane direction.

The detection of the target substance is conducted in the same manner as in Example 1 except that the external magnetic field 176 is applied in the in-film direction. That is, external magnetic field 181 is applied in the rightward direction to magnetic particle 164 fixed to the surface of GMR element 140 through the reaction of “first peptide, target substance, and second peptide molecule” to direct rightward the magnetization of magnetic particle 164. Thereby magnetic particle 164 produces a floating magnetic field in free layer 240 in the direction reverse to the applied external magnetic field 176 (the magnetization direction of magnetic particle 164). Therefore, presence of the magnetic particle changes the net intensity of the magnetic field applied to the GMR element, and the difference results in difference in the voltage applied to the GMR element. By the above described process, target substance 173 in a specimen solution can be detected.

The detecting process in this Example illustrated in FIG. 8B is compared below with that of comparative example illustrated in FIG. 8C. In this Example, the first peptide molecule is Fab region molecule 161b of an anti-HEL antibody, and the second peptide molecule is diabody 162b capable of identifying simultaneously both HEL and gold. On the other hand, in the comparative example, the first peptide molecule is anti-HEL polychronal antibody 161c, and the second peptide molecule is also anti-HEL polychronal antibody 162c as in conventional techniques.

First polypeptide molecule 161 capable of identifying the HEL, namely Fab region molecule 161b of anti-HEL antibody in this Example, and anti-HEL polychronal antibody 161c in comparable example are immobilized on the detecting device in the same manner as in Example 1.

On the other hand, second peptide molecule 162 is immobilized as described below since magnetic microparticle 164 is coated with gold colloid film 165 in this Example.

In this Example, the second peptide is diabody 162b capable of identifying simultaneously both HEL and gold. The diabody is immobilized as below on the gold without special treatment. Specifically, the magnetic microparticles are dispersed in a phosphate buffer solution containing 0.1% (v/v) Tween 20 (hereinafter referred to as a PBST solution, occasionally). To this dispersion, is added a solution of the aforementioned diabody in a PBST solution. The mixture is incubated at 30° C. for two hours. The magnetic microparticles are collected by a magnet, and washed with a PBST solution. The obtained magnetic particles immobilize thereon diabody 162b which is capable of identifying simultaneously both HEL and gold.

In the comparative example, anti-HEL polychronal antibody 162c as the second peptide molecule is immobilized as below. The aforementioned magnetic microparticles are added to a solution of dithiobis(succinimidyl hexanoate) (supplied by Dojin Kagaku Kenkyusho K.K.) in chloroform, and reaction is allowed to proceed at room temperature for one minute. Then the magnetic microparticles are collected by a magnet, washed with chloroform, and dried by gaseous nitrogen. To the resulting surface-activated esterified magnetic microparticle, the Fab region molecule of the anti-HEL antibody is bonded by amine coupling to obtain a magnetic microparticle immobilizing the Fab region molecule of the ant-HEL antibody on the surface.

With such a detecting device, HEL is detected according to the same protocol as the one in Example 1. Assuming the diameter of magnetic microparticle 164 to be 400 nm, the average distance between the surface of GMR element 140 and magnetic microparticle 164 is about 55 nm in the comparative example, whereas the distance is about 35 nm in this Example. Correspondingly, the greater change of the voltage is detected in this Example than the in comparative example, improving the detection sensitivity.

### Example 3

HEL is used as the model protein of the target substance similarly as in Example 1. A diabody capable of identifying simultaneously both the HEL and gold is used as the first peptide molecule for identifying specifically and bonding to a specific region of the target substance. An anti-HEL polychronal antibody is used as the second peptide molecule for identifying specifically and bonding to another region of the target substance different from the region identified by the first peptide molecule. The detecting is conducted with a semiconductor Hall element in this Example to describe the effect of the present invention.

The diabody capable of identifying simultaneously both HEL and gold, which is used as the first peptide molecule in this Example, is prepared in the same manner as in Example 2. The anti-HEL polychronal antibody, which used as the second peptide molecule in this Example, is obtained from Rockland Co. The preparation of the element and the process of the measurement are based on the procedure disclosed in the International Publication No. WO2003/067258.

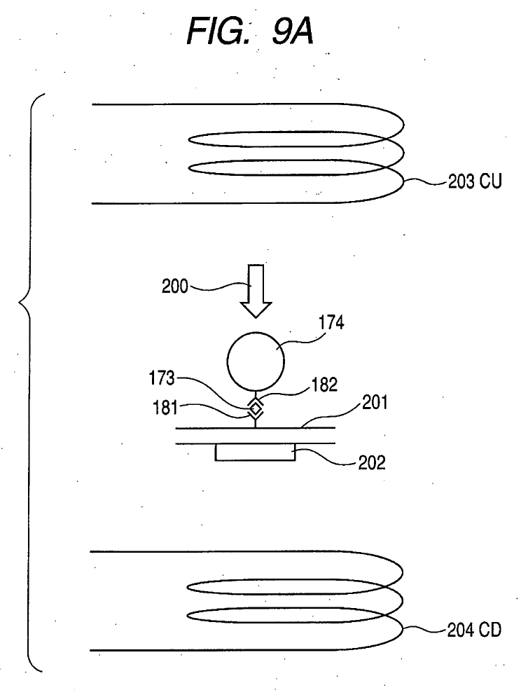

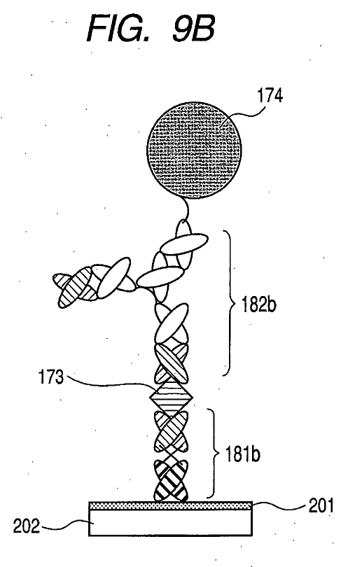

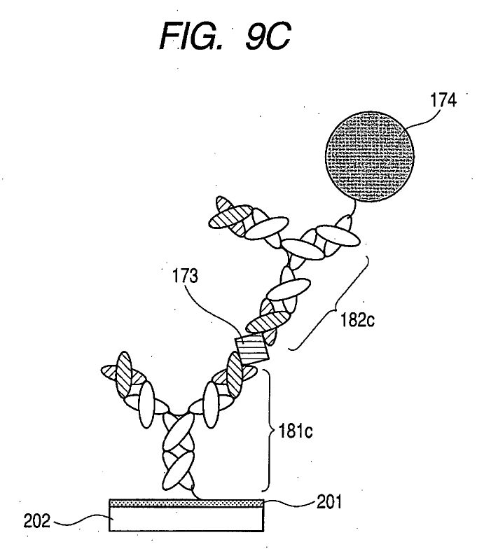

The principle of detecting with the biodetector of the present invention is described by reference to FIG. 9A. FIG. 9A illustrates schematically a cross-section of semiconductor Hall element 202 of detector chip 201 and periphery thereof. First peptide molecule 181 is immobilized on the surface of semiconductor Hall element 202. Target substance 173 bonds specifically to first peptide 181. To the target substance 173, magnetic particle 174 comes to be bonded through specific bonding between second peptide 182 immobilized on the surface of the magnetic particle 174 and target substance 173.

Upper coil CU 203 (first magnetic field-generating means) is placed in opposition to the surface of detector chip 201. Upper coil CU 203 is energized to generate a magnetic field in a state that magnetic particle 174 is bonded to the surface of the detector chip 201 as described above. The coil may be replaced by a permanent magnet. In FIG. 9A, the magnetic fluxes are formed in the direction indicated by arrow mark 200 perpendicular to the semiconductor Hall element face. Magnetic particle 174, when present, makes the magnetic fluxes to converge to increase the magnetic flux density at semiconductor Hall element 202. Further, the magnetic flux density is higher with increase of the distance from detector chip 201 since the magnetic field is applied by upper coil CU 203. Therefore, the free magnetic particles not bonded to the surface of detector chip 201 are attracted upward not to affect the magnetic flux density to be detected by semiconductor Hall element 202. The voltage outputted from semiconductor Hall element 202 is proportional to the magnetic flux density. Therefore, the presence of magnetic particle 174 bonded to semiconductor Hall element 202 can be determined by the output voltage.

When the presence of plural magnetic molecules is detected by one semiconductor Hall element 202, the increase of the magnetic flux density converged by magnetic particle 174 depends on the number of the magnetic particles. Thereby the number of magnetic particles 174 bonded to one semiconductor Hall element 202 can be determined.

In an embodiment, lower coil CD 204 (second magnetic field-generating means) is placed on the back side of detector chip 201. This lower coil CD 204 generates a magnetic field to attract magnetic particle 174 toward the surface of detector chip 201, not to detect magnetic particle 174. This lower coil may be replaced by a permanent magnet. Lower coil CD 204 is energized when magnetic particle 174 is introduced to detector chip 201 to generate a magnetic field. Since the magnetic flux density decreases with the distance from the surface of detector chip 201, the magnetic particle is attracted to the surface of detector chip 201 to shorten the time for bonding of magnetic particle 174 to the surface of detector chip 201.

With this detecting device, HEL is detected according to the protocol below. First peptide molecule 181 capable of identifying the HEL is immobilized to the detecting device.

(1) The detecting device is immersed in a phosphate-buffered physiological saline solution containing HEL, namely target substance 173, and is incubated for five minutes.

(2) Unreacted HEL is washed off with the phosphate-buffered physiological saline solution.

(3) The detecting device after the above steps (1) and (2) is immersed in a phosphate-buffered physiological saline solution containing second peptide molecule 182 marked with magnetic particle 174, and is incubated for five minutes.

(4) An unreacted marked antibody is washed off with the phosphate-buffered physiological saline solution.

In the state of the above step (1), a magnetic field is applied by the lower coil. Since the magnetic flux density decreases with the distance from the surface of the detector chip, the magnetic particle is attracted to the surface of the detector chip to accelerate the bonding of the magnetic particle to the surface of the detector chip.

Next, with the magnetic particle bonded to the detector chip surface, the magnetic field of the lower coil is turned off, and the output of the Hall element is obtained without application of a magnetic field to the detector chip.

Thereafter, a magnetic field is applied by the upper coil and the output signal from the Hall element is taken out. The output obtained above at the zero magnetic field and the output with the magnetic field applied by the upper coil are compared. Similarly, the relative outputs are compared with the detector element having no magnetic particle. From the differences in the relative outputs, the concentration of the magnetic particles, namely the concentration of the target substance is detected.

The detecting process in this Example illustrated in FIG. 9B is compared with that of comparative example illustrated in FIG. 9C. In this Example, the first peptide molecule is diabody 181b capable of identifying simultaneously both HEL and gold, and the second peptide molecule is anti-HEL polychronal antibody 182b. In the comparative example, the first peptide molecule is anti-HEL polychronal antibody 181c, and the second peptide molecule is also anti-HEL polychronal antibody 182c as in conventional techniques.

In the constitution of this Example illustrated in FIG. 9B, diabody 181b as the first peptide capable of identifying simultaneously both HEL and gold is immobilized on the detector chip through the steps as follows: a gold thin film is formed on the detector chip surface by sputtering or vapor deposition, the detector chip is immersed in a solution of the diabody in PBST, incubation is conducted at 30° C. for two hours, and the detector chip is taken out and washed with a PBST solution.

In the constitution of the comparative example illustrated in FIG. 9C, the anti-HEL polychronal antibody 181c is immobilized on the detector chip through the steps as follows for comparison with the Example: a gold thin film is formed on the detector chip surface by sputtering or vapor deposition, the gold film is allowed to react with dithiobis(succinimidyl hexanoate) (Dojin Kagaku Kenkyusho Co.) in chloroform at room temperature for one minute, the detector chip is washed with chloroform, and is dried with gaseous nitrogen, the anti-HEL polychronal antibody is immobilized by amine-coupling on the surface active esterified gold surface of the detector chip.

In the Example and comparative example, the anti-HEL polychronal antibody is immobilized according to the method described in Example 1.

In the above Example, the distance between the magnetic microparticle and the detector chip is decreased by 10 nm than the distance in the comparative example, and correspondingly the detection sensitivity is improved.

### Example 4

HEL is used as the model protein of the target substance similarly as in Example 1. An scFv of anti-HEL antibody is used as the first peptide molecule capable of identifying specifically and bonding to a specific region of the target substance. An Fab region molecule of the anti-HEL antibody is used as the second peptide molecule for identifying specifically and bonding to another region of the target substance different from the region identified by the first peptide molecule. A method using a superconductive quantum interference device (SQUID) is used as the detecting method to describe the effect of the present invention. Each of the first and second peptide molecules is immobilized on the detector surface or the magnetic microparticle in the same manner as in Example 1.

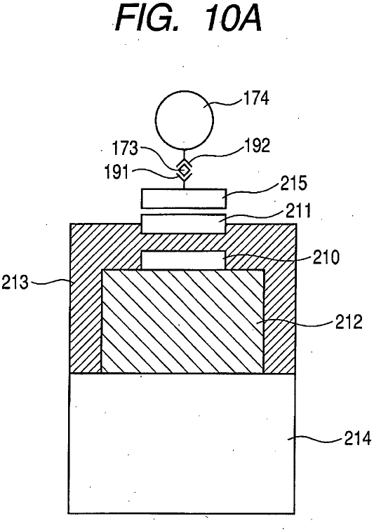

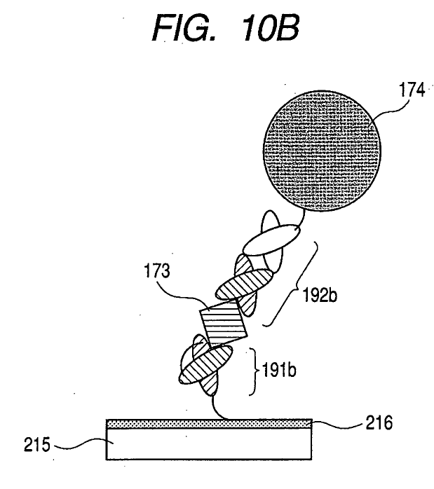

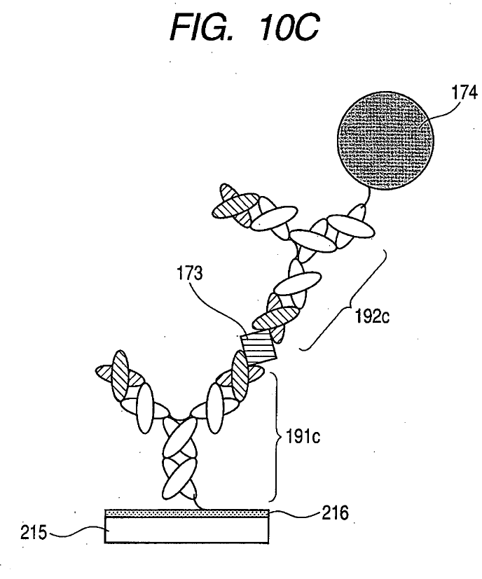

The preparation of the element and the measurement are conducted according to the method described in Japanese Patent Application Laid-Open No. 2005-291909. FIG. 10A illustrates the constitution of the device. First peptide molecule 191 is immobilized on substrate 215. First peptide molecule 191 comes to bond specifically to target substance 173. Second peptide molecule 192 which is fixed to magnetic microparticle 174 comes to bond to target substance 173. Thus the magnetic microparticle is immobilized on the substrate. Substrate 215 immobilizing the magnetic microparticle is placed on a SQUID device. The outside of the device is covered with heat-insulating material 213. Sapphire window 211 is provided below the substrate. SQUID element 210 supported by sapphire column 212 is placed below sapphire window 211. The SQUID device is placed on liquid nitrogen container 214. With the device of this constitution, the detecting is conducted as described in Japanese Patent Application Laid-Open No. 2005-291909.

The constitution of the present invention illustrated in FIG. 10B is compared with comparative example illustrated in FIG. 10C. In this Example, the first peptide molecule is scFv 191b of an anti-HEL antibody, and the second peptide molecule is Fab region molecule 192b of anti-HEL antibody. In the comparative example, the first peptide molecule is anti-HEL polychronal antibody 191c, and the second peptide molecule is also anti-HEL polychronal antibody 192c.

The immobilization of the first peptide molecule on the substrate, and the immobilization of the second peptide molecule on the magnetic microparticle are conducted in the same manner as in Example 1. The immobilization of the magnetic microparticle through the first peptide molecule, the target substance, and the second peptide molecule is also conducted in the same manner as in Example 1.

As the result, the distance between the SQUID element and the magnetic microparticle is shorter by about 20 nm in this Example than that in the comparative example. Therefore, detected voltage change is greater in the Example than in comparative example, and correspondingly the detection sensitivity is improved.

According to the preferred embodiment of the present invention, a high-detective target-detecting element, a detecting material, and a detecting kit can be provided in combination with a magnetic marker and a magnetic field-detecting element for use for detecting the presence or concentration of a target substance with high detection sensitivity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-102985, filed Apr. 4, 2006, which is hereby incorporated by reference herein in its entirety.

What is claimed is:

1. An element for detecting a target substance in a specimen or measuring the concentration of the target substance in cooperation with a magnetic marker, comprising a magnetic field-detecting site, a peptide molecule capable of bonding specifically to the target substance and a site for immobilizing the peptide molecule; the peptide molecule having a molecular weight lower than an immunoglobulin G molecule.

2. The target substance-detecting element according to claim 1, wherein the magnetic field-detecting site contains any of a magnetoresistance effect element, a Hall effect element, a magnetic impedance element, and a superconductive quantum interference device.

3. A target substance-detecting material as a magnetic marker for detecting a target substance in a specimen or measuring the concentration of the target substance in cooperation with a magnetic field-detecting element,
comprising a particle containing a magnetic substance, and a peptide molecule capable of bonding specifically to the target substance which peptide is immobilized to the surface of the particle;
the peptide molecule having a molecular weight lower than an immunoglobulin G molecule.

4. The target substance-detecting material according to claim 3, wherein the magnetic field-detecting element contains any of a magnetoresistance effect element, a Hall effect element, a magnetic impedance element, and a superconductive quantum interference device.

5. A kit for detecting a target substance in a specimen or measuring the concentration of the target substance,
comprising an element comprising a magnetic field-detecting site, a first peptide molecule capable of bonding specifically to the target substance and a site for immobilizing the first peptide molecule;
a marker material comprising a particle containing a magnetic material and a second peptide molecule capable of bonding specifically to the target substance which second peptide molecule is immobilized on the particle;
the first peptide molecule and the second peptide molecule being bonded specifically at different regions of the target substance; and
at least one of the first peptide molecule and the second peptide molecule having a molecular weight lower than an immunoglobulin G molecule.

6. The kit for detecting a target substance according to claim 5, wherein the magnetic field-detecting site contains any of a magnetoresistance effect element, a Hall effect element, a magnetic impedance element, and a superconductive quantum interference device.
